(19) United States
(12) Patent Application Publication
(10) Pub. No.: US 2010/0052359 A1
(43) Pub. Date: Mar. 4, 2010

(54) Window Surround with Stamped Cap

(76) Inventor: Peter J. Ellis, Rochester Hills, MI (US)

Correspondence Address: MAGNA INTERNATIONAL, INC., 337 MAGNA DRIVE, AURORA, ON, L4G-7K1, CA

(21) Appl. No.: 12/532,432

(22) PCT Filed: Mar. 26, 2008
(86) PCT No.: PCT/CA08/00549

§ 371 Date: Sep. 22, 2009

Related U.S. Application Data
(60) Provisional application No. 60/920,350, filed on Mar. 27, 2007.

(51) Int. Cl. B60J 1/08

(52) U.S. Cl. 296/146.1

(57) ABSTRACT

A window surround assembly is provided for a motor vehicle door frame defining a window opening. The window surround assembly includes a fixed windowpane adapted to be disposed within a portion of the window opening. An upper reveal extends along a top edge of the fixed windowpane and is adapted to be mounted to a portion of the motor vehicle door frame. An outer belt extends along a bottom edge of the fixed windowpane and is adapted to be mounted to a portion of the motor vehicle door frame. A window encapsulation is molded to an outer periphery of the fixed windowpane to secure the upper reveal and the outer belt to the fixed windowpane. A cap is fixedly secured to and extends along the upper reveal and the outer belt to provide the window surround assembly with a seamless, joint-free appearance.

### BACKGROUND

1. Field of the Invention

The invention relates to a window surround for a motor vehicle door. More particularly, the invention relates to a window surround including a stamped cap.

2. Description of Related Art

A rear door of a motor vehicle often includes both retractable and fixed window panes disposed within a window opening. The fixed window pane is typically smaller that the retractable window pane and is separated therefrom by a rigid division post. Typically, the rear door also includes a header trim for receiving the retractable window pane as the retractable window pane moves between its open and closed positions.

The individual installation of each of the above-mentioned components to the rear door at an original equipment manufacturer (OEM) is a labor-intensive, and therefore, costly operation. For this reason, window modules have been developed for rear doors in order to reduce the assembly costs previously incurred at the OEM. Generally, such window modules involve pre-assembling each of the individual components at a location remote from the OEM and then delivering the pre-assembled window module to the OEM for installation along the rear door of the motor vehicle. As a result, installation at the OEM is a cost-effective, one-step process.

### SUMMARY

According to one aspect of the invention, a window surround assembly is provided for a motor vehicle door frame defining a window opening. The window surround assembly includes a fixed windowpane adapted to be disposed within a portion of the window opening. An upper reveal extends along a top edge of the fixed windowpane and is adapted to be mounted to a portion of the motor vehicle door frame. An outer belt extends along a bottom edge of the fixed windowpane and is adapted to be mounted to a portion of the motor vehicle door frame. A window encapsulation is molded to an outer periphery of the fixed windowpane to secure the upper reveal and the outer belt thereto. A cap is fixedly secured to and extends along the upper reveal and the outer belt to provide the window surround assembly with a seamless, joint-free appearance.

### BRIEF DESCRIPTION OF THE DRAWINGS

The invention will be readily appreciated as the same becomes better understood by reference to the following detailed description when considered in connection with the accompanying drawings wherein:

FIG. 1 is a perspective view of a window surround assembly for front and rear doors of a motor vehicle;

FIG. 2 is a cross-sectional view taken along Lines 2-2 in FIG. 1 of an upper reveal with a cap fixedly secured thereto; and

FIG. 3 is a cross-sectional view taken along Lines 3-3 in FIG. 1 of an outer belt with the cap fixedly secured thereto.

### DETAILED DESCRIPTION OF THE EMBODIMENTS

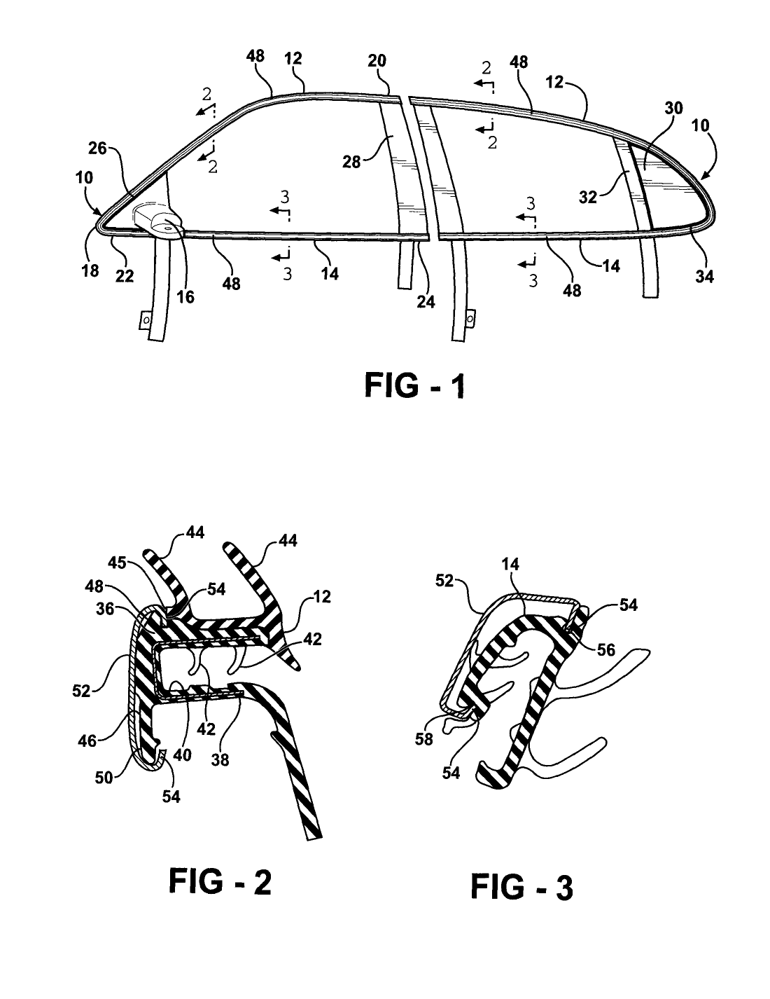

Referring to FIG. 1, a window surround assembly, generally shown at 10, is provided for front and rear doors of a motor vehicle. The window surround assembly 10 for the front door includes an upper reveal or upper reveal molding 12, an outer belt or outer belt molding 14, and a mirror patch 16. The upper reveal 12 extends between a front end 18 and a back end 20, and conforms to the curvature of an upper edge of a window opening. The outer belt 14, which may be formed from thermoplastic vulcanisate (TPV) or thermoplastic olefin (TPO), is generally linear and extends between a front end 22 and a back end 24. A mirror encapsulation 26 is molded to the outer periphery of the mirror patch 16 to secure the front ends 18, 22 of the respective upper reveal 12 and outer belt 14 thereto. A B-pillar appliqué 28 extends between the back end 20 of the upper reveal 12 and the back end 24 of the outer belt 14.

The window surround assembly 10 for the rear door of the motor vehicle includes the upper reveal 12, the outer belt 14, a fixed window pane 30, and a division post 32. A window encapsulation 34 is molded to the outer periphery of the fixed window pane 30 to secure the upper reveal 12, the outer belt 14, and the division post 32 thereto. It is appreciated that the window encapsulation 34 may also be utilized for a front door that includes a fixed windowpane. Thus, the window surround assembly 10 for each of the front and rear doors is a modular assembly that can be pre-assembled away from the motor vehicle and then shipped as a single piece for installation to the corresponding motor vehicle door frame.

Referring to FIG. 2, the upper reveal 12 includes a main body portion 36. The upper reveal 12 may be formed from thermoplastic vulcanisate (TPV). A carrier 38 is embedded within the main body portion 36 to provide a rigid support therefor. The carrier 38 may be generally U-shaped. The main body portion 36 defines a channel 40 for receiving a flange of the motor vehicle door frame. At least one retention finger 42 extends into the channel 40 to hold the flange therewithin. The upper reveal 12 also includes at least one sealing lip 44 for sealingly engaging the motor vehicle body when the door is closed. The main body portion 36 defines a retention slot 45 located between a portion of the main body portion 36 and one of the sealing lips 44.

The upper reveal 12 includes a reveal surface 46 that is typically visible along the motor vehicle exterior. The reveal surface 46 extends between an upper end 48 and an opposing lower end 50. A cap 52 is fixedly secured to the upper reveal 12 and covers the reveal surface 46. The cap 52 includes locking ends 54 that are fixed into place against the upper reveal 12. In one embodiment, the locking ends 54 extend inwardly and fit around the respective upper 48 and lower 50 ends of the reveal surface 46. One of the locking ends 54 may be shaped to be received within the retention slot 45 to further secure the cap 52 in place. The cap 52 is an elongated one-piece stamped member that covers the reveal surface 46 from the upper end 48 to the lower end 50. The cap 52 may be formed from any of numerous materials including, but not limited to, stainless steel, aluminum, and a molded material having a high gloss black with film.

Referring to FIG. 3, the cap 52 also extends along the outer belt 14 and is fixedly secured thereto. More specifically, the outer belt 14 includes upper 56 and lower 58 receiving slots for receiving the locking ends 54 of the cap 52.

The cap 52 extends as a single piece along the entire length of the upper reveal 12 and the outer belt 14. The cap 52 thus is a visible surface extending along the window opening of the front or rear door. Because the cap 52 is a one-piece stamped member, the cap 52 provides a seamless, joint-free appearance along the entire length of the upper reveal 12 and outer belt 14 when fixedly secured thereto. The window surround assembly 10 is thus free from any visible joints or surface interruptions that would otherwise take away from the appearance of the window surround assembly 10. And since the cap 52 may be formed from any of numerous materials, the particular look of the cap 52 may be chosen to complement the overall appearance of the motor vehicle. Further, the cap 52 is easy to attach to the upper reveal 12 and outer belt 14.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A window surround assembly for a motor vehicle door frame defining a window opening, said window surround assembly comprising:
a fixed windowpane adapted to be disposed within a portion of the window opening;
an upper reveal extending along a top edge of said fixed windowpane and adapted to be mounted to a portion of the motor vehicle door frame;
an outer belt extending along a bottom edge of said fixed windowpane and adapted to be mounted to a portion of the motor vehicle door frame;
a window encapsulation molded to an outer periphery of said fixed windowpane to secure said upper reveal and said outer belt to said fixed windowpane; and
a cap fixedly secured to and extending along said upper reveal and said outer belt to provide said window surround assembly with a seamless, joint-free appearance.

2. A window surround assembly as set forth in claim 1 wherein said upper reveal includes a reveal surface extending between opposing upper and lower ends.

3. A window surround assembly as set forth in claim 2 wherein said cap includes a pair of locking ends extending around said respective upper and lower ends to secure said cap to said upper reveal.

4. A window surround assembly as set forth in claim 3 wherein said upper reveal includes a retention slot proximate said upper end for receiving one of said pair of locking ends therein.

5. A window surround assembly as set forth in claim 1 wherein said outer belt defines upper and lower receiving slots for receiving said respective pair of locking ends to secure said cap to said outer belt.

6. A window surround assembly as set forth in claim 5 wherein said cap includes a pair of locking ends received within said respective upper and lower receiving slots to secure said cap to said outer belt.

7. A window surround assembly for a motor vehicle door frame defining a window opening, said window surround assembly comprising:
a mirror patch adapted to be disposed within a portion of the window opening;
an upper reveal extending along a top edge of said mirror patch and adapted to be mounted to a portion of the motor vehicle door frame;
an outer belt extending along a bottom edge of the mirror patch and adapted to be mounted to a portion of the motor vehicle door frame;
a mirror encapsulation molded to an outer periphery of said mirror patch to secure said upper reveal and said outer belt to said mirror patch; and
a cap fixedly secured to and extending along said upper reveal and said outer belt to provide said window surround assembly with a seamless, joint-free appearance.

8. A window surround assembly as set forth in claim 7 wherein said upper reveal includes a reveal surface extending between opposing upper and lower ends.

9. A window surround assembly as set forth in claim 8 wherein said cap includes a pair of locking ends extending around said respective upper and lower ends to secure said cap to said upper reveal.

10. A window surround assembly as set forth in claim 9 wherein said upper reveal includes a retention slot proximate said upper end for receiving one of said pair of locking ends therein.

11. A window surround assembly as set forth in claim 7 wherein said cap includes a pair of locking ends received within said respective upper and lower receiving slots to secure said cap to said outer belt.

12. A window surround assembly as set forth in claim 11 wherein said outer belt defines upper and lower receiving slots for receiving said respective pair of locking ends to secure said cap to said outer belt.

13. A window surround assembly for a motor vehicle door frame defining a window opening, said window surround assembly comprising:
an upper reveal molding adapted to be mounted to a first portion of the motor vehicle door frame;
an outer belt molding coupled to said upper reveal molding and adapted to be mounted to a second portion of the motor vehicle door frame; and
a one-piece cap fixedly secured to and extending along said upper reveal molding and said outer belt molding to provide said window surround assembly with a seamless, joint-free appearance.

14. A window surround assembly as set forth in claim 13 wherein said one-piece cap includes a pair of locking ends for lockingly engaging at least one of said upper reveal molding and said outer belt molding.

15. A window surround assembly as set forth in claim 14 wherein said upper reveal molding includes a retention slot for receiving one of said pair of locking ends to secure said one-piece cap to said upper reveal molding.

16. A window surround assembly as set forth in claim 15 wherein said upper reveal molding includes a main body portion and a carrier embedded therewithin.

17. A window surround assembly as set forth in claim 14 wherein said outer belt molding includes upper and lower receiving slots for receiving said respective pair of locking ends to secure said cap to said outer belt molding.
